(19) United States
(12) Patent Application Publication
(10) Pub. No.: US 2016/0018253 A1
(43) Pub. Date: Jan. 21, 2016

(54) Case By Case Picking Weight Audit System

(71) Applicant: Encompass Technologies, LLP, Fort Collins, CO (US)

(72) Inventor: Jonathan W. O'Neil, Fort Collins, CO (US)

(73) Assignee: Encompass Technologies, LLP, Fort Collins, CO (US)

(21) Appl. No.: 14/804,526

(22) Filed: Jul. 21, 2015

Related U.S. Application Data
(60) Provisional application No. 62/027,176, filed on Jul. 21, 2014.

(51) Int. Cl. G01G 19/08; G01G 23/01; G01G 23/14

(52) U.S. Cl. CPC G01G 19/083; G01G 23/14; G01G 23/01

(57) ABSTRACT

A computer-implemented case by case picking weight audit system and a method of auditing weight for case by case picking which includes weight audit controller including a case by case picking weight audit program executable to provide communication between a mobile scale and the mobile device for transfer of mobile scale weight data and comparison of an audit product weight against a picked product weight placed on the mobile scale.

This United States Non-Provisional patent application claims the benefit of U.S. Provisional Patent Application No. 62/027,176, filed Jul. 21, 2014, hereby incorporated by reference herein.

### I. FIELD OF THE INVENTION

A computer-implemented case by case picking weight audit system and a method of auditing weight for case by case picking which includes a weight audit controller containing a case by case picking weight audit program executable to convert a load cell signal from a load cell of a mobile scale into a picked product weight value corresponding to picked product weight positioned on said mobile scale and to compare the picked product weight value to a picked product weight audit value with generation of a weight variance signal upon occurrence of a weight variance between the picked product weight value and the picked product weight audit value which can be transmitted to discrete computer device.

### II. BACKGROUND OF THE INVENTION

Conventional case by case picking systems may require a person to travel to the location of a product(s) and pick the product from inventory. The picked product may be positioned on a portable platform or pallet along with other prior or subsequently picked products (hereinafter referred to as “a picked product pallet”). The entire picked product pallet may then be weighed to determine whether the picked products positioned on the pallet are correct. If the picked product pallet weight varies from the expected picked product pallet weight, the variance can be due to pallet to pallet differences in weight, an incorrectly picked product, or an incorrectly picked quantity of a picked product. Regardless of the cause of the weight variance, the entire picked product pallet may have to be disassembled to attribute the weight variance to one or more of the pallet, incorrectly picked product or incorrect quantity of a picked product. The incorrectly picked product(s) or quantity of picked products may then be removed from the picked product pallet and the picked product pallet may then be reassembled for shipment.

There would be an advantage in providing a case by case picking weight audit system which deducted the pallet weight prior to any picked product being positioned on the pallet and subsequently deducted the picked product pallet weight prior to any subsequent picked product being disposed on the picked product pallet, and which concurrently provided sensorially perceivable weight variance indicia upon positioning of an incorrect picked product or quantity of picked product on the picked product pallet.

### III. SUMMARY OF THE INVENTION

Accordingly a broad object of particular embodiments of the invention can be to provide a computer implemented case by case picking weight audit system including a weight audit controller adapted to receive a load cell signal from one or more load cells of a mobile scale and communicate with a computer device discrete from the weight audit controller. The weight audit controller including a controller processor in communication with a controller memory element containing a case by case picking weight audit program code (also referred to as the “program code”) can function to transform the load cell signal into a picked product weight value corresponding to the picked product weight of the picked product on the mobile scale, and to compare the picked product weight value to a picked product weight audit value corresponding to a pre-determined picked product weight of the picked product on the mobile scale, and to generate a weight variance signal upon occurrence of a weight variance between the picked product weight value and the picked product weight audit value, and to generate a sensorially perceivable weight discrepancy indicia.

Another broad object of particular embodiments of the invention can be to provide a computer device having a computer processor in communication a computer memory element which contains the program code, whether in whole or in part, executable to depict a graphical user interface on the display surface of the computer device which by picker interaction configures the computer device to provide a picked product pallet image in which a plurality of picked products of a picked product pallet are collectively depicted or individually depicted in serial priority order for picking and positioning on the mobile scale by a picker. The computer device in communication with the weight audit controller validates conformance of the case by case picking to the serial priority order depicted in the picked product pallet image by comparing the picked product weight value to the picked product weight audit value with any variance resulting in generation of a sensorially perceivable weight variance indicia indicating to the picker that a picked product positioned on the picked product pallet is inconsistent with the serial priority order depicted in the picked product pallet image depicted on the display surface of the computer device.

Naturally, further objects of the invention are disclosed throughout other areas of the specification, drawings, photographs, and claims.

### IV. BRIEF DESCRIPTION OF THE DRAWINGS

FIG. 1 is a block diagram of a particular embodiment of the inventive computer implemented case by case weight audit system.

FIG. 2 is block diagram of a particular embodiment of the inventive weight audit controller.

FIG. 3 is a block diagram of an inventive computer device adapted to communicate with the weight audit controller.

FIG. 4 is a perspective view of a particular embodiment of the weight audit controller.

FIG. 5 is an illustration of a particular embodiment of a graphical user interface which by picker interaction executes the program code to configure particular embodiments of the inventive case by case picking system including selection, coordination and calibration of the functionalities of a mobile scale, a weight audit controller and a computer device to implement the computer implemented system for and method of case by case picking.

FIG. 6 is an illustration of a particular embodiment of a graphical user interface which by picker interaction executes the computer code to configure particular embodiments of the inventive case by case picking system including connectivity and selection of a data transfer mode from plurality of data transfer modes between the weight audit controller and the computer device and calibration of a mobile scale including one or more load cells.

FIG. 7 is an illustration of a particular embodiment of a graphical user interface which depicts a picked product pallet image including a plurality of picked products in serial priority order to be picked and positioned on the mobile scale.

FIG. 8 is an illustration of a particular embodiment of a graphical user interface which depicts a first picked product image including a first picked product weight image having a picked product weight value and a pick product quantity value and a total picked product weight audit value for a first picked product.

FIG. 9 is an illustration of a particular embodiment of a user interactive graphical which depicts a first picked product image including a first picked product weight image having a product weight image including a picked product weight value representing a first of three quantities of a picked product positioned on the first picked product pallet.

FIG. 10 is an illustration of a particular embodiment of a user interactive graphical which depicts a first picked product image including a first picked product weight image having a product weight image including a picked product weight value representing a second of three quantities of a picked product positioned on the first picked product pallet.

FIG. 11 is an illustration of a particular embodiment of a user interactive graphical which depicts a first picked product image including a first picked product weight image having a product weight image including a picked product weight value representing a three of three quantities of a picked product positioned on the first picked product pallet.

FIG. 12 is an illustration of a particular embodiment of a graphical user interface which depicts a second picked product image including a second picked product weight image having a picked product weight value and a pick product quantity value and a total picked product weight audit value for a second picked product.

FIG. 13 is an illustration of a particular embodiment of a graphical user interface which depicts a picked product universal product code image including a universal product code field finable with a universal product code by picker interaction.

FIG. 14 is an illustration of a particular embodiment of a user interactive graphical image which depicts a second case by case picking image for a second picked product pallet.

### V. DETAILED DESCRIPTION OF THE INVENTION

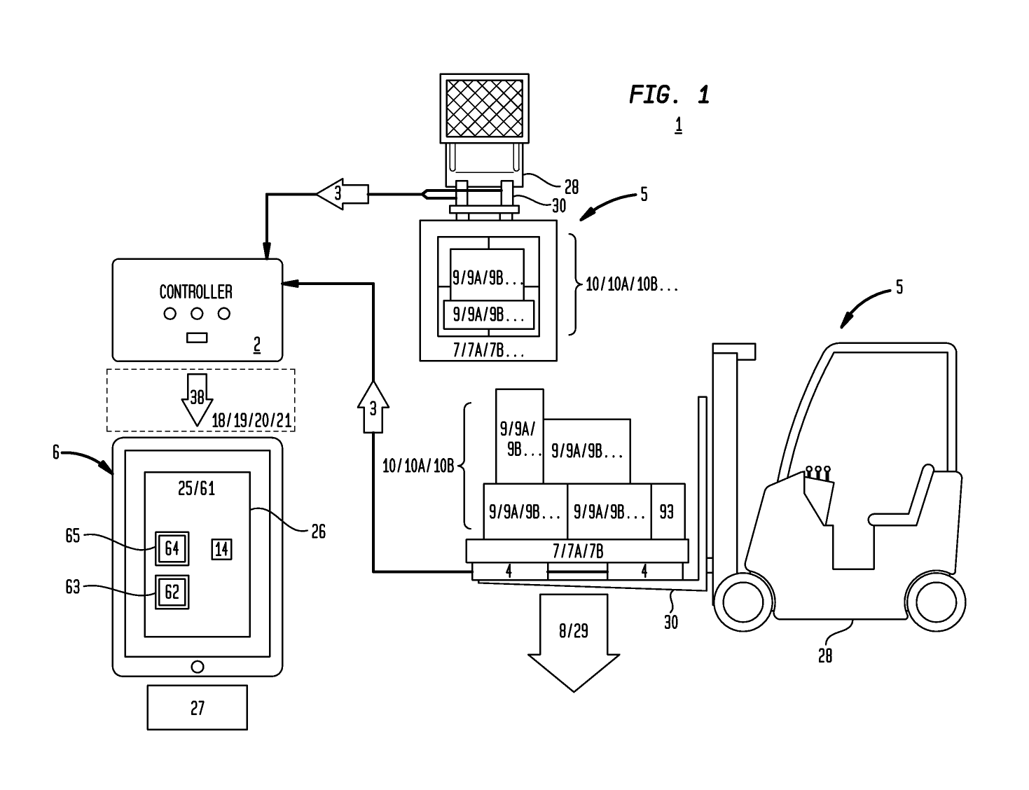

Now referring primarily to FIG. 1, which provides a general overview of an illustrative embodiment of an inventive computer implemented weight audit system (1) including a weight audit controller (2) adapted to receive a load cell signal (3) from one or more load cells (4) of a mobile scale (5) and communicate with a computer device (6) discrete from the weight audit controller (2). The load cells (4) of the mobile scale (5) can be directly or indirectly engaged with a picked product pallet (7) having a picked product pallet weight (8) which varies based upon a picked product (9) or a plurality of picked products (10) placed on the picked product pallet (7). The load cells (4) can generate a load cell signal (3) which varies based on change in the picked product pallet weight (8). The weight audit controller (2) further functions to transform the load cell signal (3) into a picked product weight value (11) and further functions to compare the picked product weight value (11) to a picked product weight audit value (12), and can further function to generate a weight variance signal (13) upon occurrence of a weight variance between the picked product weight value (11) and the picked product weight audit value (12) which results in generation of a sensorial perceivable weight discrepancy indicia (14) by the weight audit controller (2) or the computer device (5).

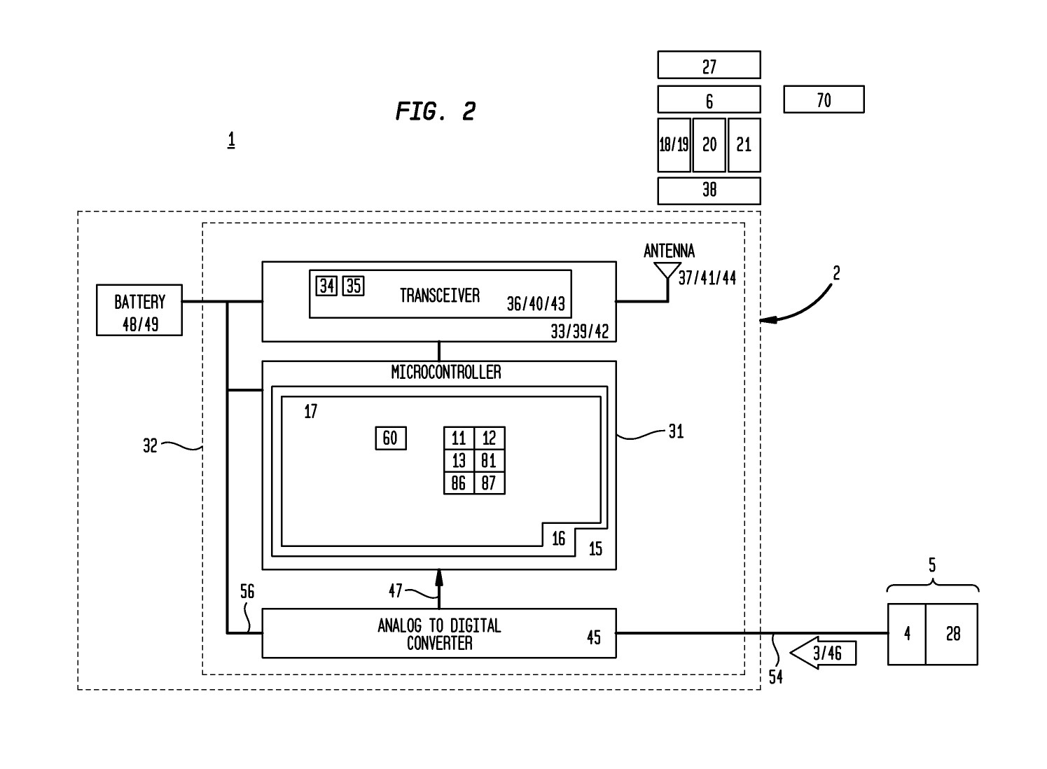

Now referring primarily to FIG. 2, which provides a block diagram of an illustrative example of a weight audit controller (2). The term “weight audit controller” means for the purposes of this invention a device including a controller processor (15) in communication with a controller memory (16) which contains, in whole or in part, the a case by case picking weight audit program code (also referred to as the “program code”) (17) and can be further adapted to communicate with a computer device (6), whether wirelessly or wired, through a wide area network (18), such as the Internet (19), a local area network (20), a personal area network (21) such as Bluetooth or Wi-Fi, or the like.

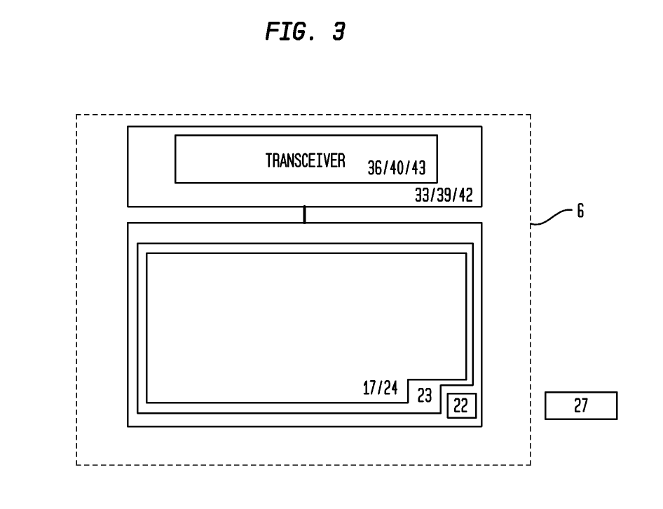

Now referring primarily to FIG. 3, which provides a block diagram of an illustrative example of a computer device (6). The term “computer device” means for the purposes of this invention any device adapted to communicate with the weight audit controller (2) including a computer processor (22) in communication with computer memory element (23), or a machine readable medium (24), containing the program code (17) executable to depict a graphical user interface (25) on a display surface (26) of the computer device (6) interactive with a picker (27). The computer device (6) can as to particular embodiments take the form of a portable limited-capability computer designed specifically for communicating with the weight audit controller (2); however, other embodiments can take the form of set-top boxes, intelligent televisions connected to receive data through an entertainment medium such as a cable television network or a digital satellite broadcast, hand-held devices such as smart phones (whether iOS or Android operating system), slate or pad computers, personal digital assistants or camera/cell telephones, or multiprocessor systems, microprocessor-based or programmable consumer electronics, network personal computers, minicomputers, mainframe computers, or the like, or combinations thereof.

The term “mobile scale” means for the purposes of this invention a mobile vehicle (28) including one or more load cells (4) which can be made directly or indirectly responsive to an amount of force (29) of a picked product (9) or a plurality of picked products (10) carried by the mobile vehicle (28). While the mobile vehicle (28) depicted in FIG. 1 includes a pronged device (30) in front configured to carry a picked product pallet (7) on which a picked product (9) or a plurality of picked products (10) can be positioned; it is not intended that the mobile device (28) be limited to such a configuration, but rather, can be any device capable of movement adapted to carry a picked product (9) or a plurality of picked products (10) to which one or more load cells (4) can be affixed in a manner responsive to the weight of the picked product (9) or plurality of picked products (10) and without limitation to the breadth of the foregoing, including: a pallet jack, a pallet truck, a fork lift, a pallet lift, or the like, or combinations thereof.

The term “load cell” means for the purposes of this invention means a transducer that can be coupled to a mobile vehicle (28) to convert an amount force (29) into a load cell signal (3) which can be digitized and scaled to calculate a picked product weight value (11) corresponding to the actual weight of a picked product (9) or group of picked product(s) (10) placed on a picked product pallet (7). Any of a numerous and wide variety of load cells (4) exist suitable for use in embodiments of the invention including, but not necessarily limited to hydraulic load cells, pneumatic load cells, strain gauge load cells, or the like or combinations thereof.

The term “picked product pallet” means for the purposes of this invention means a portable platform or pallet on which a picked product(s) (9) (10) can or have been placed, positioned, or located.

The term “picked product pallet weight” for the purposes of this invention means the force (30) exerted by gravity on a picked product pallet (7) including any picked product(s) (9) (10).

The term “pick count” for the purposes of this invention means the number of picked product(s) (9) placed, positioned, or located on a pick product pallet (7) between each calculation of a picked product pallet weight (8).

The term “tare weight” means for the purposes of this invention means an amount of weight subtracted from the gross weight (whether the weight of an empty picked product pallet (7) or the weight of picked product pallet (7) laden with picked product(s) (9) (10) to determine the net weight of a singular picked product (9) or a group of picked products (10) positioned on the mobile scale (5).

The term “picked product” means for the purposes of this invention any discrete material thing which can be picked, and without limitation to the breadth of the forgoing, including: an article, an object, an item, a commodity, a product, an artifact, a consumer goods, or the like or combinations thereof.

The term “pick or picked or picking” for the purpose of this invention means to choose or select one picked product (9) or a group of picked products (10).

The term “picker” for the purposes of this invention means a person that picks a picked product (9) or a group of picked products (10).

Again referring primarily to FIG. 1, particular embodiments of the weight audit system (1) include a mobile scale (5) configured to move a picked product pallet (6) to one or a plurality of locations to receive picked products (9). The mobile scale (5) includes one or more load cells (4) affixed at locations to receive all, or substantially all, the forces (29) associated with the picked product pallet (7) such that the load cell signal (3) can vary based on change in the amount of forces (29) associated with change in picked product pallet weight (8) with sufficient precision to distinguish between picked products (9). A weight audit controller (2) can be affixed or removably coupled to the mobile scale (5) at any location which allows normal use of the mobile scale (5) and allows wired or wireless communication between the weight audit controller (2) and the one or more load cells (4) to receive the load cell signal (3).

Now referring primarily to FIG. 2, a block diagram and flowchart illustration supports combinations of elements for performing the specified functions, combinations of steps for performing the specified functions, and executable program elements for performing the specified functions of the case by case picking weight audit system (1). Each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. As to particular embodiments, the weight audit controller (3) can include the controller processor (15) in communication with a controller memory element (16) which can, but need not necessarily, take the form of a microcontroller (31) having a single integrated circuit (32). The controller memory element (16) can be in the form of a non-volatile computer storage medium that can be erased and reprogrammed and can further include a random access memory for data storage. The controller memory element (16) can contain the program code (17) executable to provide specified functions or combinations of steps for performing the specified functions of the case by case picking weight audit system (1).

As to particular embodiments, the weight audit controller (2) can, but need not necessarily include, a communication controller (33) which can include a signal receiver (34) and a signal sender (35) (or combined as a transceiver (36)) having an associated antenna (37) to send and receive communication signals (38) to and from a computer device (6) discrete from the weight audit controller (2). As to particular embodiments, the communication controller (33) can, but need not necessarily, be a BLUETOOTH controller (39) (for example a Texas Instruments CC2540 BLUETOOTH System-on-Chip) including the associated BLUETOOTH transceiver (40) and BLUETOOTH antenna (41). The BLUETOOTH controller (39) can operate a BLUETOOTH protocol V4.0 BLE having an operating frequency of 2.4 GHz ISM. As to particular embodiments, the communication controller (33) can be a Wi-Fi controller (42) and the associated Wi-Fi transceiver (43) and Wi-Fi antenna (44). The communication controller (33) can also be configured to support iOS 6.0 or Android 4.3 or the operating systems of other computer devices (6).

As to particular embodiments, the weight audit controller (2) can, but need not necessarily include, an analog to digital converter (45) to convert the load cell signal (3) from a continuously variable analog signal (46) to a digital signal (47).

Again referring primarily to FIG. 2, embodiments of the weight audit controller (2) can, but need not necessarily, be coupled to a controller power source (48) adapted to provide direct current in a range of about 7 VDC to about 15 VDC. As to particular embodiments, the controller power source (48) can provide direct current at +12.6 volts. The controller power source (48) can take the form of a +12.6 VDC lithium polymer battery (49) configured to provide current at 9800 mAh for about 170 hours.

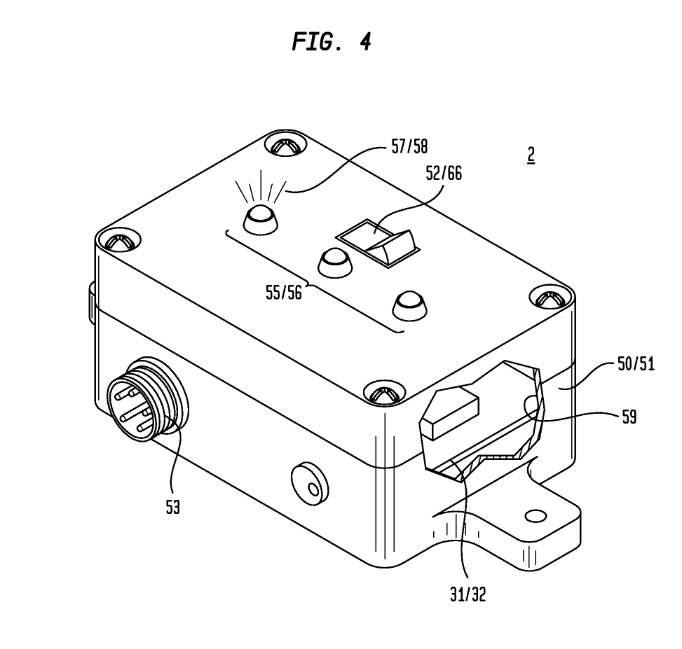

Now referring primarily to FIGS. 2 and 4, the weight audit controller (2) can, but need not necessarily, include a housing (50) having an external surface (51) configured to mount a power switch (52) and a cable wire coupler (53). A load cell cable (54) can, but need not necessarily, be connected between one or more load cells (4) and the wire cable coupler (53); although certain embodiments may be configured for wireless communication. The housing (50) can be further configured to mount one or more indicator elements (55) such as light emitting diodes (56) to provide sensorially perceivable controller operating indicia (57) such as an amount of light (58) correspondingly colored to particular operating parameters of the weight audit controller (2). The housing (50) further includes a housing internal surface (59) which defines a housing internal space (60) in which the controller components and associated circuitry can be housed.

Now referring primarily to FIGS. 1 through 13, the program code (17) can be contained in the controller memory element (16), or can be contained in the computer memory element (23), or can be distributed or downloadable between the controller memory element (16) and the computer memory element (23). The program code (17) can include a graphical user interface module (60) executable to depict a graphical user interface (25) including one or more user interactive graphical images (61) on a display surface (26) of a computer device (6). The term “user interaction” (also referred to as “picker interaction”) for the purposes of this invention means execution of the program code (17), whether in whole or in part, through the use of a command, including, as one illustrative example, a touch (62) on the display surface (26) of the computer device (6) over a control image (63)(or other interactive field) displayed in an interactive graphical image (61) to activate a function of the weight audit system (1). However, it is not intended that the term “user interaction” or “picker interaction” be limited to a touch (62) over a control image (63), rather, it is intended to broadly encompass a command by the picker (27) through which a function of program code (17) can be activated or performed, whether through selection of one or a plurality of control images (63), entering a control element (64) into a control field (65), or by click event, user voice command, keyboard stroke, mouse button, or otherwise. It is further intended that control images (63) can be configured or displayed in any manner capable of user interaction including as illustrative examples: drop down lists including a plurality of selectable control images, slider images, switch images, control images configured as a square, a rectangle, circles, bullets, point, a circle, a triangle, a square, a polygon (or other geometric configurations or combinations or permutations thereof), or the like, or combinations thereof.

Additionally, while a preferred embodiment of the invention is described in the general context of computer-executable instructions of the program code (17) which utilize routines, programs, objects, components, data structures, or the like, to perform particular functions or tasks or implement particular abstract data types, or the like, being executed by the computer code (17), it is not intended that any embodiments of the invention be limited to a particular set of computer-executable instructions or protocols.

Now referring primarily to FIGS. 2 and 4, the power switch (52) of the weight audit controller (2) can be switched to the on condition (66) and the communication controller (33) can accept a connection with the computer device (6). The computer device (6) connected to the weight audit controller (2) can executed the program code (17) to generate and depict the graphical user interface (25) on the display surface (26) of the computer device (6).

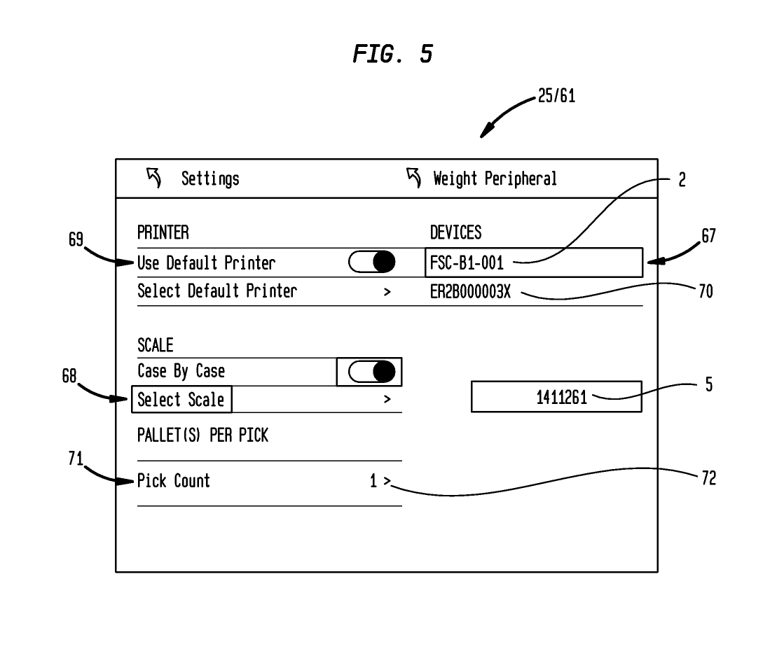

Now referring primarily to FIG. 5, the program code (17) is further executable to depict one or more interactive graphical image(s) (61) on the display surface (26) of the computer device (6) which by picker interaction allows execution of the program code (17) to configure the computer device (6). As to particular embodiments, the computer device (6) can be configured by picker interaction with a weight audit controller selector image (67) to select one weight audit controller (2) from a plurality of weight audit controllers (2). As to particular embodiments, the program code (17) can be executed to depict a mobile scale selector image (68) which allows selection by picker interaction of a mobile scale (5) including one or more load cells (3) from a plurality of mobile scales (5). As to particular embodiments, the program code (17) is executable to depict a printer selection image (69) which by picker interaction allows selection of printer (70) from a plurality of printers (70). The program code (17) by picker selection of each particular one of the weight audit controller (2), mobile scale (5) and printer (70) is further executed to coordinate the communication and operation of these discrete devices, taking in account the particular configuration of each, to allow calibration and conversion of the load cell signal (3) from the selected one of the plurality of mobile scales (5) into picked product pallet weight values (11) which are sufficiently consistent with the actual picked product pallet weights (8) to allow identification and differentiation of each picked product (9) positioned on the picked product pallet (7).

As to particular embodiments, the computer code (17) is further executable to depict a pick count image (71) which by picker interaction allows selection of a pick count (72), as above defined, from a plurality of pick counts (72). The pick count (72) in the example of FIG. 5 is shown as the number “1”. Accordingly, the program code (17) will be activated to calculate the picked product pallet weight (8) each time a picked product (9) is placed, positioned, or located on a pick product pallet (7), as further described below.

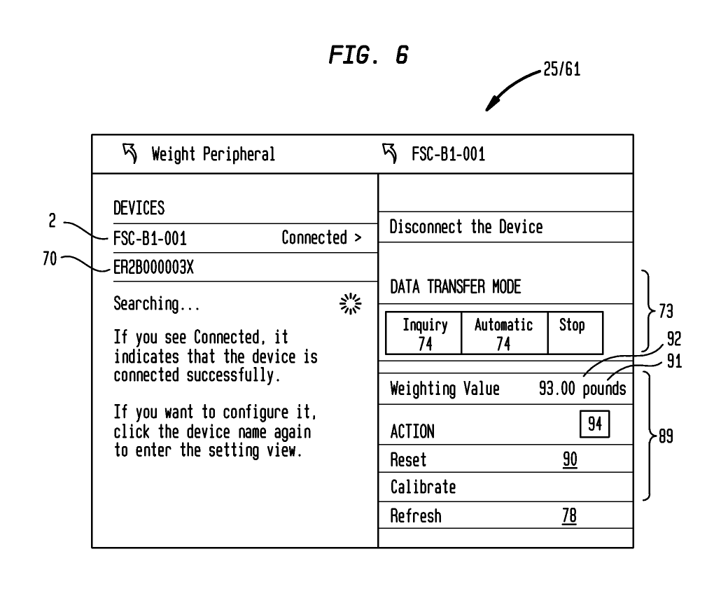

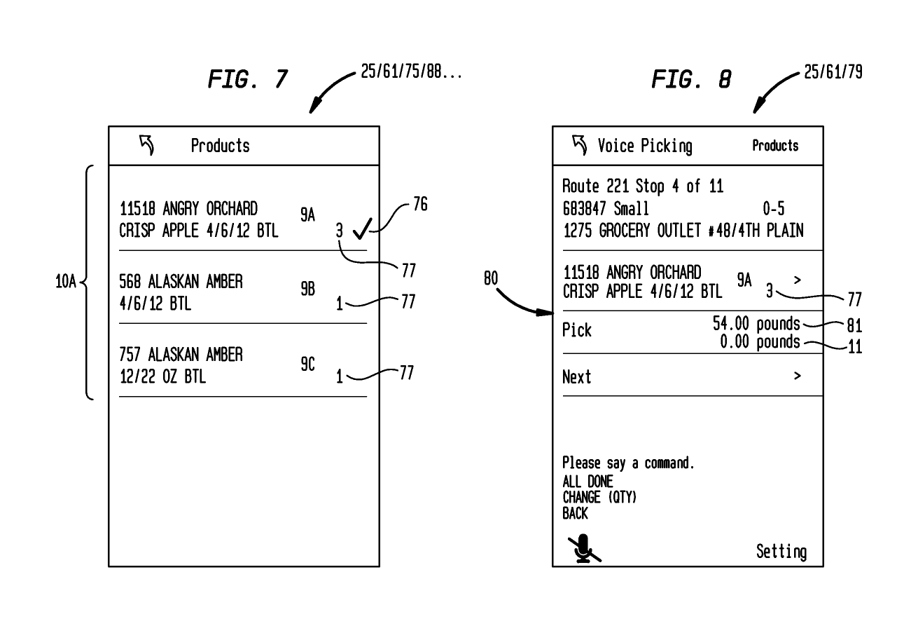

Now referring primarily to FIGS. 6 and 7, the program code (17) can be further executed to depict an interactive graphical image (61) on the display surface (26) on the computer device (6) which by picker interaction with a data transfer mode image (73) allows selection of one of a plurality of data transfer modes (74). As shown in the example of FIG. 6, the picker (27) can select a first of the plurality of data transfer modes (74) (shown in the example of FIG. 6 as the selectable icon “Automatic”) which causes the program code (17) to depict a first picked product pallet image (75) on the display surface (26) of the computer device (6) (as shown in the example of FIG. 7). The first picked product pallet image (75) represents a first plurality of picked products (10A) to be picked and positioned on a first picked product pallet (7A) carried by a mobile scale (5). The computer code (17) can further operate to depict the first plurality of picked products (10A) in the first picked product pallet image (75) in a serial priority pick order. In the example of FIG. 6, the program code (17) functions to depict first picked product pallet image (75) as a first plurality of picked products (10A) in a serial priority pick order and can, but need not necessarily, depict a sensorially perceivable case by case picking indicia (76) (shown in the example as a check mark symbol “√”) to indicate the first picked product (9A) to be picked and positioned on a first picked product pallet (7A) on the mobile scale (5). The program code (17) can further function to depict a picked product quantity value (77) in proximity to each one of the first plurality of picked products (10A) representing the quantity of a picked product (9) to be picked. The picker (27) then picks and positions the first picked product (9A) on the first picked product pallet (7A) (as shown in the example of FIG. 1). Upon picker (27) positioning a first picked product (9A) from the list of the first plurality of picked products (10A) on the first picked product pallet (7A), the program code (17) is further executed to calculate a picked product weight value (11) of the first picked product (9A), if the picked product weight value (11) substantially matches the picked product weight audit value (12), the computer code (17) can depict the sensorially perceivable case by case picking indicia (76) to indicate the second picked product (9B) to be picked and positioned on a first picked product pallet (7A) on the mobile scale (5).

Again referring to the example of FIG. 7, the picker can select a second of the plurality of data transfer modes (74) (shown in the example of FIG. 6 as the selectable icon “Inquiry Mode”) which causes the program code (17) to depict a first picked product pallet image (75) on the display surface (26) of the computer device (6), as above described. Upon picker (27) positioning of the first picked product (9A) on the first picked product pallet (7A) and by subsequent picker interaction with a refresh image (78) on the display surface (26) of the computer device (6), the computer code (17) then functions to calculate the picked product weight value (11), if the pick product weight value (11) substantially matches a picked product weight audit value (12) for the first picked product (9A), then the computer code (17) functions to depict the case by case picking indicia (76) proximate to the second picked product (9B) to be picked.

Now referring primarily to FIGS. 8 through 12, as to particular embodiments, the computer code (17) can further function to depict on the display surface (26) of the computer device (6) a first picked product image (79) corresponding to the first picked product (9A) in the serial priority pick order in the first plurality of picked products (10A), as above described, further including a total picked product weight audit value (81) (as shown in the example of FIG. 8). The total picked product weight audit value (81) can be calculated by function of the program code (17) based on the pre-determined picked product audit weight value (12) of the first picked product (9A) stored in the controller memory element (16) multiplied by the picked product quantity value (77) (in the example of FIG. 8 the first picked product (9A) has a picked product audit weight value of “18.00 pounds” multiplied by the picked product quantity value “3” equals a total picked product audit weight value of “54.00 pounds”).

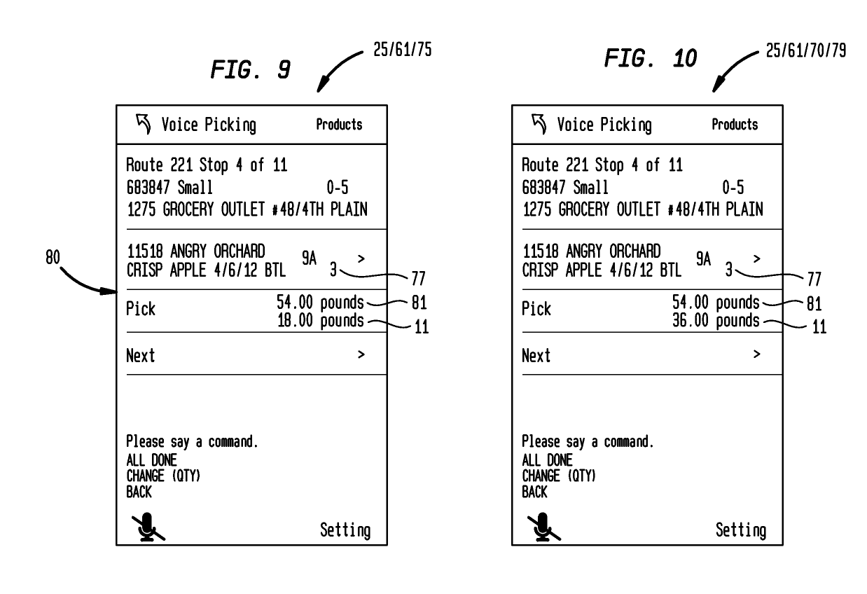

Now referring primarily to FIGS. 9 and 10, when the picker (27) positions the first picked product (9A) on the first picked product pallet (7A), the program code (17) can further function to depict a picked product weight value (11) in the first picked product image (79). As shown in the example of FIG. 9, for the first picked product (9A), the pick product quantity value (77) is shown as the number “3” and the total picked product weight audit value (81) is shown as “54.00 pounds.” Accordingly, the picker (28) positions a first of three quantities of the first picked product (82) on the first picked product pallet (7A). The computer program (17) further functions to determine the picked product weight value (11) for the first quantity of the first picked product (9A) and then functions to depict the picked product weight value (11) for the first quantity of the first picked product (9A) (shown as “18 pounds” in the example of FIG. 9). If the picker (28) correctly picks and positions a second quantity of the first picked product (9A) on the first picked product pallet (7A), the program code (17) functions to depict the picked product weight value (11) corresponding to 36.00 pounds (as shown in the example of FIG. 10) and if the picker (28) correctly picks and positions a third quantity of the first picked product (9A) on the first picked product pallet (7A), the program code (17) functions to depict the picked product weight value (11) corresponding to 54.00 pounds (as shown in the example of FIG. 11).

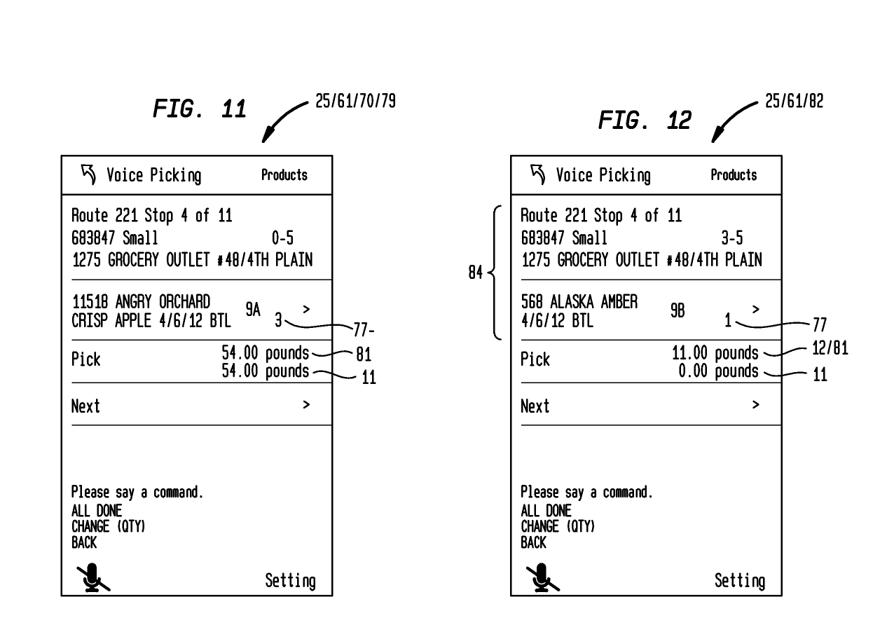

Again referring to primarily to FIGS. 6 and 12, if the picker (27) selected the data transfer mode image (73) shown as “Automatic Mode” in FIG. 6, the program code (17) further functions to compare the picked product weight value (11) with the picked product weight audit value (12), and if the compared picked product weight value (11) substantially matches the picked product weight audit value (12), then computer code (17) can function to depict a second picked product image (82) to be picked and positioned on the first picked product pallet (7A) (as shown in the example of FIG. 12). In the alternative, if the picker (27) selected the data transfer mode image (73) shown as “Inquiry Mode” in FIG. 6, then the computer code (17) further functions to display the refresh image (78) which by picker interaction causes the program code (17) to audit the picked product pallet weight (8), and if the picked product pallet weight (8), is correct the computer code (17) tares the first picked product pallet (7A) and further functions to depict a second picked product image (82).

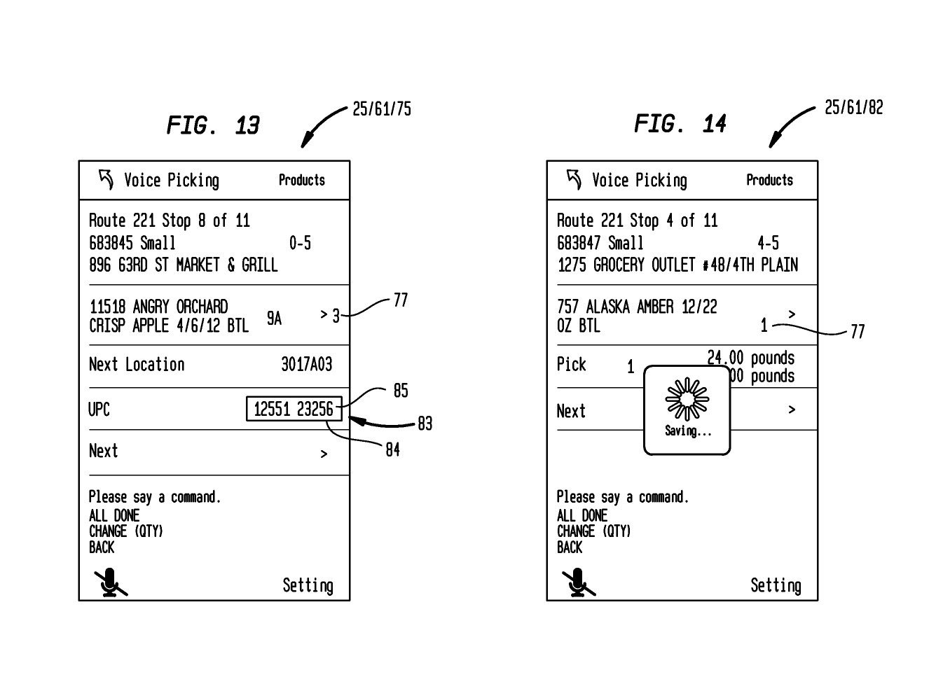

Now referring primarily to FIG. 13, the program code (17) can further function to depict a picked product universal product code image (83) in the first picked product image (79). The picked product universal code image (83) can include a universal product code field (84) fillable by picker interaction (such as scanning a bar code on the first picked product (9A)) with a universal product code (85). Entry of the universal product code (85) by the picker (27) into the universal product code field (84) causes the program code (17) to compare the universal product code (85) against a universal product code reference (86) contained in the controller memory element (16) for the first picked product (9A). If the universal product code (85) filled or scanned in by the picker (27) matches the universal product code reference (86) for the first picked product (9A), then the computer code (17) functions to verify the universal product code (85) filled or scanned in by the picker (27) and functions to depict a second picked product image (82).

Now referring primarily to FIG. 14, once the picker (27) has picked all of the first plurality of picked products (10A) displayed in the a first picked product pallet image (75), the computer code (17) can further function to compare a first picked product pallet weight (8A) against a first picked product pallet audit weight value (87), and if the first picked product pallet weight (8A) substantially matches the first picked pallet weight audit value (87), the computer code (17) can function to display a second case by case picking image (88) for a second picked product pallet (7B).

Again referring primarily to FIG. 6, the computer code (17) can further function to depict a calibration image (89) on the display surface (26) of the computer device (6) which by picker interaction causes the computer code (17) to calibrate the selected one of a plurality of mobile scales (5). As to the example shown in FIG. 5, the computer code (17) can be executed by user interaction with a reset image (90) to tare the selected one of the plurality of mobile scales (5) by taring the weight of the first picked product pallet (7A) empty of any picked products (9). The picker (27) can then enter a calibration weight value (91) into a calibration weight value field (92) (as shown in the example of FIG. 5, the calibration weight value is “93.00 pounds”). The picker (27) can than position a calibration weight (93) having an amount of weight corresponding to the calibration weight value (91) (in the instant example, 93.00 pounds) on the first picked product pallet (7A). The computer code (17) can in turn calibrate the selected one of the mobile scales (5) such that the picked product weight values (11) of the picked products (9) subsequently positioned on the first picked product pallet (7A) determined based on the calibration weight (93). The computer code (17) can further function to provide a sensorially perceivable calibration indicia (94) of correct calibration of the first picked product pallet (7A).

As can be easily understood from the foregoing, the basic concepts of the present invention may be embodied in a variety of ways. The invention involves numerous and varied embodiments of an inventory control system and methods for making and using such inventory control system.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “sensor” should be understood to encompass disclosure of the act of “sensing”—whether explicitly discussed or not—and, conversely, were there effectively disclosure of the act of “sensing”, such a disclosure should be understood to encompass disclosure of a “sensor” and even a “means for sensing.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the case by case weight audit devices and systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A weight audit system, comprising:
a mobile scale having a load cell, said load cell capable of generating a load cell signal which varies based upon an amount of force applied to said load cell, said amount of force corresponding to a picked product weight of picked products positioned upon said mobile scale;
a weight audit controller in communication with said load cell, including:
a controller signal receiver capable of receiving said load cell signal;
a controller processor;
a controller memory element;
a program code contained in said controller memory element, said controller code executable by said controller processor to:
digitize said load cell signal received by said receiver from said load cell;
convert said load cell signal into a picked product weight value corresponding to said picked product weight positioned on said mobile scale;
retrieve a picked product weight audit value corresponding to a pre-determined picked product weight of said picked product;
compare said picked product weight value to a picked product weight audit value;
generate a weight variance signal upon occurrence of a weight variance between the picked product weight value and the picked product weight audit value; and
a controller signal sender capable of transmitting said weight variance signal.

2. The system of claim 1, further comprising:
a computer device discrete from said weight audit controller, said computer device including:
a computer receiver adapted to receive said weight variance signal;
a computer processor;
a computer memory element in communication with said computer processor;
a computer code contained in said computer memory element, said computer code executable to:
decode said weight variance signal received by said computer receiver; and
depict a sensorially perceivable weight variance indicia on a display surface of said computer device.

3. The system of claim 2, wherein said computer code is further executable to depict a graphical user interface on said display surface of said computer device, said graphical user interface including one or more graphical images adapted for interaction with a picker.

4. The system of claim 3, wherein said computer code is further executable to depict a weight audit controller selector image which allows by picker interaction selection of said weight audit controller from a plurality of weight audit controllers.

5. The system of claim 4, wherein said computer code is further executable to depict a mobile scale selector image which allows selection by picker interaction of said mobile scale including said load cell from a plurality of mobile scales.

6. The system of claim 5, wherein said computer code is further executable to depict a pick count image which by picker interaction allows selection of a pick count from a plurality of pick counts.

7. The system of claim 6, wherein said computer code is further executable to depict a printer section image which by user interaction allows selection of printer from a plurality of printers.

8. The system of claim 7, wherein said computer code is further executable to:
depict a picked product pallet image including a plurality of picked products on said display surface of said computer;
serially order pick of said plurality of picked products;
depict a first picked product image from said plurality of picked products; and
depict a sensorially perceivable weight variance indicia upon occurrence of a variance between said picked product weight value of a first picked product positioned on said mobile scale and said picked product audit weight value.

9. The system of claim 8, wherein said computer code is further executable to depict a second picked product image from said plurality of picked products upon occurrence of a match between said picked product weight value of a first picked product positioned on said mobile scale and said picked product audit weight value associated with said first picked product.

10. The system of claim 9, wherein said computer code is further executable to depict a pick product quantity image associated with said picked product image.

11. The system claim 10, wherein said computer code is further executable to depict a picked product weight value image on said on said display surface of said computer device which corresponds to the picked product weight of said picked product positioned on said mobile scale.

12. The system of claim 11, wherein said computer code is further executable to:
depict a universal product code image on said display surface of said computer device including a universal product code field fillable by picker interaction with a universal product code associated with a picked product positioned on said mobile scale;
compare said universal product code entered into said universal product code field with a universal product code reference associated with said picked product; and
depict a sensorially perceivable universal product code variance indicia on said display surface of said computer device upon occurrence of a variance between said universal product code and said universal product code reference.

13. The system of claim 12, wherein said computer code is further executable to depict a refresh image on said display surface of said computer device, said refresh image upon picker interaction causes said computer code to further:
calculate a picked product weight value of a picked product pallet weight; and
calculate a picked product weight audit value of a picked product pallet weight;
compare said picked product weight value to said picked product weight audit value; and
depict said sensorially perceivable weight variance indicia upon occurrence of a variance between said picked product weight value and said picked product weight audit value.

14. The system of claim 13, wherein said computer code further executable to:
depict a calibration image on said display surface of said computer device including a calibration weight field fillable by picker interaction with a tare weight value;
tare said mobile scale based upon comparison of a tare weight positioned on said mobile scale to said tare weight value entered by said picker; and
depict a sensorially perceivable calibration indicia on said display surface of said computer device.

15. The system of claim 14, wherein said computer code further executable to:
depict a calibration image on said display surface of said computer device including a calibration weight field fellable by picker interaction with a tare weight value, wherein said tare weight value is zero; and
tare said mobile scale to zero offsetting said amount of force applied to said load cell of said mobile scale.

16-30. (canceled)
